(19) United States
(12) Patent Application Publication
(10) Pub. No.: US 2023/0286449 A1
(43) Pub. Date: Sep. 14, 2023

(54) SYSTEM FOR MOUNTING AN ACOUSTIC SHIELD ABOVE A MOTOR VEHICLE ENGINE

(71) Applicant: Treves Products, Services & Innovation, Paris (FR)

(72) Inventors: David Drezet, Paris (FR); Carlos Martins, Paris (FR)

(21) Appl. No.: 18/018,510

(22) PCT Filed: Jul. 27, 2021
(86) PCT No.: PCT/EP2021/070936

§ 371 Date: Jan. 27, 2023

(30) Foreign Application Priority Data
Jul. 30, 2020 (FR) FR2008110

(51) Int. Cl. B60R 13/08; F02B 77/11

(52) U.S. Cl. CPC B60R 13/0838; F02B 77/11

(57) ABSTRACT

A system for mounting an acoustic shield above a motor vehicle engine, including a shank having a head and a block of molded elastomer provided with a housing into which the head can be inserted, the housing having a nominal size that allows it to accept, as a close fit, a head of analogous nominal size, the wall of the housing having at least one break in continuity configured as a bellows so that, through deformation of the wall in the region of the break in continuity, the size of the housing can be enlarged to allow it to accept a head of size greater than the nominal size.

### BACKGROUND

The invention relates to a system for mounting an acoustic shield above a motor vehicle engine, a block of such a system and a shield provided with such a block.

It is known to make a system for mounting an acoustic shield above a motor vehicle engine, said system comprising:
a shank intended to be secured to said engine, said shank projecting upwards, said shank having at its free end a head projecting radially (the term “radially” being considered with reference to the axis of extension of said shank),
an area of said shield forming a fastening area,
a block made of moulded elastomer for receiving said head, said block being secured to said area, said block being provided with a housing for receiving said head interlocked, the opening of said housing being reduced compared to its size and to the size of said head, so that the insertion of said head into said housing is done with a temporary widening of said opening and that said head is blocked in said housing by return of said opening to its nominal size, said housing having a nominal size enabling it to receive in close fit a head of analogous nominal size.

However, it is frequently observed that, from one vehicle to another, the size of the head is variable, being variable for example between 8 and 14 mm.

This results in the need to have a specific block for each shank, depending on the size of its head, which generates additional manufacturing costs.

### SUMMARY OF THE DISCLOSURE

The invention aims to overcome this drawback.

To this end, and according to a first aspect, the invention provides a system for mounting an acoustic shield above a motor vehicle engine, said system comprising:
a shank intended to be secured to said engine, said shank projecting upwards, said shank having at its free end a head projecting radially,
an area of said shield forming a fastening area,
a block made of moulded elastomer for receiving said head, said block being secured to said area, said block being provided with a housing for receiving said head interlocked, the opening of said housing being reduced compared to its size and to the size of said head, so that the insertion of said head into said housing is done with a temporary widening of said opening and that said head is blocked in said housing by return of said opening to its nominal size, said housing having a nominal size enabling it to receive in close fit a head of analogous nominal size,

the wall of said housing having at least one break in continuity configured as a bellows, so as to enable, through deformation of said wall in the region of said break in continuity, an enlargement of the size of said housing enabling it to accommodate a head with a size greater than said nominal size.

With the suggested arrangement, the size of the housing adapts to that of the head to accommodate the latter always in close fit.

To guarantee a close fit between the head and the housing, a housing nominal size corresponding to a head minimum size should be selected.

Thus, it is possible to use a same block for a variety of shanks provided with heads of variable size; this results in a reduction in manufacturing costs.

Other particularities and advantages of the invention will appear in the following description, made with reference to the appended figures, wherein:

### BRIEF DESCRIPTION OF THE SEVERAL VIEWS OF THE DRAWING

FIG. 1a is a schematic view of a system according to a first embodiment, representing the case of a shank provided with a head of nominal size.

FIG. 1b is a schematic view of a system according to a first embodiment, representing the case of a shank provided with a head greater than the nominal size,

FIG. 2 is a schematic view of a system according to a second embodiment,

FIG. 3 is a schematic view of a system according to a variant of the second embodiment,

FIG. 4 is a schematic perspective view of a block according to the first embodiment.

### DETAILED DESCRIPTION OF THE PREFERRED EMBODIMENTS

Referring to the figures, a system 1 for mounting an acoustic shield 10 above a motor vehicle engine is described, said system comprising:
a shank 2 intended to be secured to said engine, said shank projecting upwards, said shank having at its free end a head 3 projecting radially—said head being herein inscribed within a substantially spherical envelope —,
an area of said shield forming a fastening area 4,
a block 5 made of molded elastomer for receiving said head, said block being secured to said area, said block being provided with a housing 6 for receiving said head interlocked, the opening 7 of said housing being reduced compared to its size and to the size of said head, so that the insertion of said head into said housing is done with a temporary widening of said opening and that said head is blocked in said housing by return of said opening to its nominal size, said housing having a nominal size enabling it to receive in close fit a head of analogous nominal size,
the wall 8 of said housing having at least one break in continuity 9 configured as a bellows, so as to enable, through deformation of said wall in the region of said break in continuity, an enlargement of the size of said housing enabling it to accommodate a head 3 with a size greater than said nominal size.

According to the represented embodiments, the wall 8 has a plurality of breaks in continuity 9—in particular two according to the represented embodiments—, so that the bellows is shaped in zigzag-like fashion.

According to the represented embodiments, at least one—in particular two according to the represented embodiments—break(s) in continuity 9 is/are located at the bottom of the housing 6, i.e. opposite its opening 7.

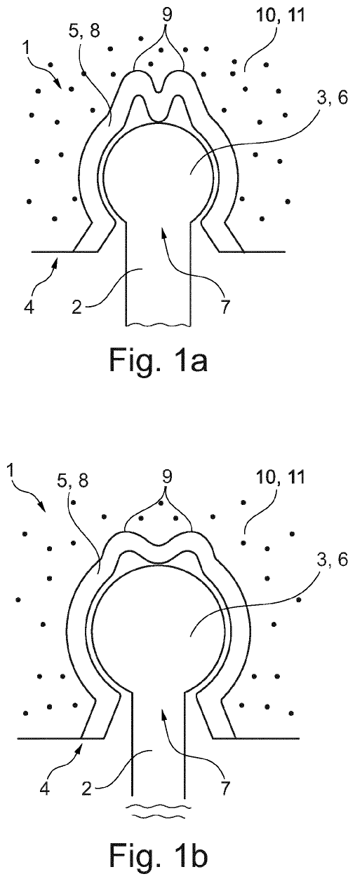

According to the first embodiment represented in FIGS. 1a and 1b, the shield 10 comprises a body 11 made of an elastically-compressible molded foam, in particular of polyurethane, the block 5 being overmolded by said body, so that said body opposes resistance to deformation of the wall 8 to reinforce anchoring of the head 3 in the housing 6.

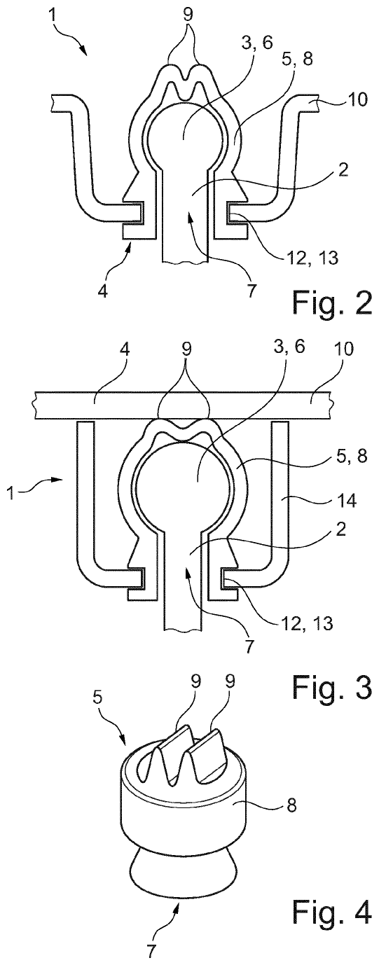

According to the second embodiment, represented in FIG. 2, the block 5 is shaped so as to have an area forming an interlocking means 12—herein shaped in the form of a peripheral groove—interlocked with a reciprocal means 13—herein shaped in the form of a peripheral projection interlocked into said groove provided in the fastening area 4.

According to the variant of the second embodiment represented in FIG. 3, the reciprocal means 13 is disposed on an intermediate part 14—in particular made of a molded plastic material—associated with the fastening area 4.

In the second embodiment and its variant, the shield 10 is for example derived from molding by hot compression of fibres, in particular glass fibres, bonded together by a bonding agent, in particular phenolic, or derived from injection molding of a thermoplastic material.

A block 5 of such a system 1 is now described, said block being made of molded elastomer, said block being provided with a housing 6 for receiving a head 3 of a shank 2, the opening 7 of said housing being reduced compared to its size and to the size of said head, so that the insertion of said head into said housing is done with a temporary widening of said opening and that said head is blocked in said housing by return of said opening to its nominal size, said housing having a nominal size enabling it to receive in close fit a head 3 of analogous nominal size, the wall 8 of said housing having at least one break in continuity 9 configured as a bellows, so as to enable, through deformation of said wall in the region of said break in continuity, an enlargement of the size of said housing enabling it to accommodate a head 3 with a size greater than said nominal size.

Finally, a shield 10 equipped with at least one such block 5 is described, said block being associated with said shield in a fastening area 4 provided on said shield.

What is claimed is:

1. A system for mounting an acoustic shield above a motor vehicle engine, said system comprising:
a shank intended to be secured to said engine, said shank projecting upwards, said shank having at its free end a head projecting radially,
an area of said shield forming a fastening area (4),
a block made of moulded elastomer for receiving said head, said block being secured to said area, said block being provided with a housing for receiving said head interlocked, the opening of said housing being reduced compared to its size and to the size of said head, so that the insertion of said head into said housing is done with a temporary widening of said opening and that said head is blocked in said housing by return of said opening to its nominal size, said housing having a nominal size enabling it to receive in close fit a head of analogous nominal size,
the wall of said housing having at least one break in continuity configured as a bellows, so as to enable, through deformation of said wall in the region of said break in continuity, an enlargement of the size of said housing enabling it to accommodate a head with a size greater than said nominal size.

2. The system according to claim 1, the wall having a plurality of breaks in continuity, so that the bellows is shaped in zigzag-like fashion.

3. The system according to claim 1, wherein at least one break in continuity located at the bottom of the housing (6).

4. The system according to claim 1, the shield comprising a body made of an elastically-compressible molded foam, the block being overmolded by said body, so that said body opposes a resistance to the deformation of the wall to reinforce anchoring of the head in the housing.

5. The system according to claim 1, the block being shaped so as to have an area forming an interlocking means interlocking with a reciprocal means provided in the fastening area.

6. The system according to claim 1, the reciprocal means being disposed on an intermediate part associated with the fastening area.

7. A block of a system according to claim 1, said block being made of molded elastomer, said block being provided with a housing for receiving a head of a shank, the opening of said housing being reduced compared to its size and to the size of said head, so that the insertion of said head into said housing is done with a temporary widening of said opening and said head being blocked in said housing by return of said opening to its nominal size, said housing having a nominal size enabling it to receive in close fit a head of analogous nominal size, the wall of said housing of the block having at least one break in continuity configured as a bellows, so as to enable, through deformation of said wall in the region of said break in continuity, an enlargement of the size of said housing enabling it to accommodate a head with a size greater than said nominal size.

8. A shield equipped with at least one block according to claim 1, said block being associated with said shield in a fastening area provided on said shield.
